(19) United States
(12) Patent Application Publication
(10) Pub. No.: US 2022/0003989 A1
(43) Pub. Date: Jan. 6, 2022

(54) VIRTUAL IMAGE DISPLAY APPARATUS AND VIRTUAL IMAGE DISPLAY METHOD

(71) Applicant: SONY CORPORATION, TOKYO (JP)

(72) Inventors: MASATOSHI NAKAMURA, TOKYO (JP); MITSUHARU MATSUMOTO, TOKYO (JP); TAKATOSHI MATSUYAMA, TOKYO (JP); MAMORU SUZUKI, TOKYO (JP); SUSUMU ICHIKAWA, TOKYO (JP)

(21) Appl. No.: 17/289,724

(22) PCT Filed: Sep. 24, 2019
(86) PCT No.: PCT/JP2019/037259

§ 371 Date: Apr. 28, 2021

(30) Foreign Application Priority Data
Nov. 9, 2018 (JP) 2018-211365
Mar. 6, 2019 (JP) 2019-040813

(51) Int. Cl. G02B 27/00; G02B 25/00

(52) U.S. Cl. CPC G02B 27/0081; G02B 27/0068; G02B 27/0075; G02B 25/001

(57) ABSTRACT

A virtual image display apparatus according to the present disclosure includes: a plurality of image forming elements (11 and 12); and a plurality of eyepiece optical systems (21 and 22). The plurality of image forming elements (11 and 12) includes a first image forming element (11) and a second image forming element (12). The first image forming element (11) outputs a first image to a front region in a visual field of a viewer. The second image forming element (12) outputs a second image to a peripheral region in the visual field of the viewer. The second image is different from the first image. The plurality of image forming elements (11 and 12) outputs a plurality of images to cause an image region of at least a portion of each of the plurality of images to overlap with the first image. The plurality of images includes the first and second images. The plurality of eyepiece optical systems (21 and 22) is provided in association with the plurality of respective image forming elements (11 and 12). The plurality of eyepiece optical systems (21 and 22) forms one virtual image as a whole from the plurality of images.

### TECHNICAL FIELD

The present disclosure relates to a head-mounted virtual image display apparatus and a virtual image display method.

### BACKGROUND ART

Head-mounted virtual image display apparatuses are requested to achieve both high resolution and wide viewing angles to increase a sense of immersion. To concurrently offer comfortable wearability, it is also necessary to reduce the size and the weight of an apparatus that is worn by a viewer.

### CITATION LIST

### Patent Literature

PTL 1: Japanese Unexamined Patent Application Publication No. 2018-5221
PTL 2: Japanese Unexamined Patent Application Publication (Published Japanese Translation of PCT Application) No. 2016-541031
PTL 3: Japanese Unexamined Patent Application Publication No. H11-84306
PTL 4: International Publication No. WO 2013/076994

### Non-Patent Literature

NPTL1: Philipp Wartenberg et al., High Frame-Rate 1″ WUXGA OLED Microdisplay and Advanced Free-Form Optics for Ultra-Compact VR Headsets, SID 2018 DIGEST, pp. 514 to 517

### SUMMARY OF THE INVENTION

It is difficult in general that a small and light-weighted head-mounted virtual image display apparatus achieves both high resolution and a wide viewing angle while suppressing the manufacturing cost.

It is desirable to provide a head-mounted virtual image display apparatus and a virtual image display method each of which makes it possible to provide a viewer with comfortable wearability and a sense of immersion.

A virtual image display apparatus according to an embodiment of the present disclosure includes: a plurality of image forming elements; and a plurality of eyepiece optical systems. The plurality of image forming elements includes a first image forming element and a second image forming element. The first image forming element outputs a first image to a front region in a visual field of a viewer. The second image forming element outputs a second image to a peripheral region in the visual field of the viewer. The second image is different from the first image. The plurality of image forming elements outputs a plurality of images to cause an image region of at least a portion of each of the plurality of images to overlap with the first image. The plurality of images includes the first and second images. The plurality of eyepiece optical systems is provided in association with the plurality of respective image forming elements. The plurality of eyepiece optical systems forms one virtual image as a whole from the plurality of images.

A virtual image display method according to an embodiment of the present disclosure includes: a step of displaying a plurality of images by a plurality of respective image forming elements; a step of outputting the plurality of images via a plurality of eyepiece optical systems corresponding to the plurality of respective image forming elements; and a step of correcting images that are displayed on the plurality of image forming elements on the basis of at least one of optical characteristics of the plurality of eyepiece optical systems, characteristics of a pencil of light rays, or light emission characteristics of the plurality of image forming elements to cause images outputted via the plurality of eyepiece optical systems to form the one virtual image. The characteristics of the pencil of light rays are geometrically determined from a pupil position and a pupil diameter of the viewer and a position and an inclination angle of a boundary surface in the eyepiece optical systems.

In the virtual image display apparatus according to the embodiment of the present disclosure, the plurality of image forming elements outputs the plurality of images to cause at least a portion of each of the plurality of images to have an image region overlapping with the first image. The plurality of images includes the first and second images. In addition, the plurality of eyepiece optical systems that is provided in association with the plurality of respective image forming elements forms one virtual image as a whole from the plurality of images.

In the virtual image display method according to the embodiment of the present disclosure, the images that are displayed on the plurality of image forming elements are corrected on the basis of at least one of the optical characteristics of the plurality of eyepiece optical systems, the characteristics of the pencil of light rays, or the light emission characteristics of the plurality of image forming elements to cause the images that are outputted via the plurality of eyepiece optical systems to form the one virtual image. The characteristics of the pencil of light rays are geometrically determined from the pupil position and the pupil diameter of the viewer and the position and the inclination angle of the boundary surface in the eyepiece optical systems.

### BRIEF DESCRIPTION OF DRAWING

FIG. 1 is a configuration diagram illustrating a disposition example and a configuration example of first to fourth image forming elements included in an optical unit for a right eye in a head-mounted virtual image display apparatus according to a first embodiment of the present disclosure.

FIG. 2 is an explanatory diagram illustrating an example of field angle regions of a plurality of respective images that is separately displayed by all of image forming elements included in respective optical units for a right eye and a left eye in the head-mounted virtual image display apparatus according to the first embodiment.

FIG. 3 is an explanatory diagram illustrating an overview of a visual field characteristic of a human eye.

FIG. 4 is a cross-sectional view illustrating a configuration example of first to fourth eyepiece optical systems included in the optical unit for a right eye in the head-mounted virtual image display apparatus according to the first embodiment along with optical paths.

FIG. 5 is a perspective view illustrating a configuration example of the first to fourth eyepiece optical systems included in the optical unit for a right eye in the head-mounted virtual image display apparatus according to the first embodiment.

FIG. 6 is an explanatory diagram illustrating an example of a visually recognized state of an image viewed by two eyepiece optical systems that are adjacent in a horizontal direction.

FIG. 7 is an explanatory diagram illustrating an example of a procedure of designing a position of a boundary surface between two eyepiece optical systems that are adjacent in the horizontal direction in the head-mounted virtual image display apparatus according to the first embodiment.

FIG. 8 is an explanatory diagram schematically illustrating an example of a field angle range of a virtual image viewed by the first and second eyepiece optical systems in the head-mounted virtual image display apparatus according to the first embodiment.

FIG. 9 is an explanatory diagram illustrating an example of a procedure of designing an inclination angle of the boundary surface between the two eyepiece optical systems that are adjacent in the horizontal direction in the head-mounted virtual image display apparatus according to the first embodiment.

FIG. 10 is an explanatory diagram illustrating a design example of a virtual image surface in the head-mounted virtual image display apparatus according to the first embodiment.

FIG. 11 is an explanatory diagram illustrating an overview of a mismatch problem with vergence distance and accommodation distance in a head-mounted virtual image display apparatus having constant virtual image distance.

FIG. 12 is an explanatory diagram illustrating an example of a movement amount of an image forming element necessary to control the virtual image distance in the head-mounted virtual image display apparatus according to the first embodiment along with a comparative example.

FIG. 13 is an explanatory diagram schematically illustrating first to third disposition examples of an imaging device for detecting a line-of-sight direction in the head-mounted virtual image display apparatus according to the first embodiment.

FIG. 14 is an explanatory diagram schematically illustrating a virtual image display method for allowing the head-mounted virtual image display apparatus according to the first embodiment to offer a natural sense of depth to a viewer.

FIG. 15 is a cross-sectional view illustrating a configuration example of first and second eyepiece optical systems included in an optical unit for a right eye in a head-mounted virtual image display apparatus according to a second embodiment along with optical paths.

FIG. 16 is a cross-sectional view illustrating a configuration example of first and second eyepiece optical systems included in an optical unit for a right eye in a head-mounted virtual image display apparatus according to a third embodiment along with optical paths.

FIG. 17 is a cross-sectional view illustrating a configuration example of first and second eyepiece optical systems included in an optical unit for a right eye in a head-mounted virtual image display apparatus according to a fourth embodiment along with optical paths.

FIG. 18 is a cross-sectional view illustrating a configuration example of first and second eyepiece optical systems included in an optical unit for a right eye in a head-mounted virtual image display apparatus according to a fifth embodiment along with optical paths.

### MODES FOR CARRYING OUT THE INVENTION

The following describes embodiments of the present disclosure in detail with reference to the drawings. It is to be noted that description is given in the following order.

### 0. Overview

### 0.1 Comparative Example

### 0.2 Overview of Head-Mounted Virtual Image Display Apparatus and Virtual Image Display

Method according to Embodiment of the Present Disclosure

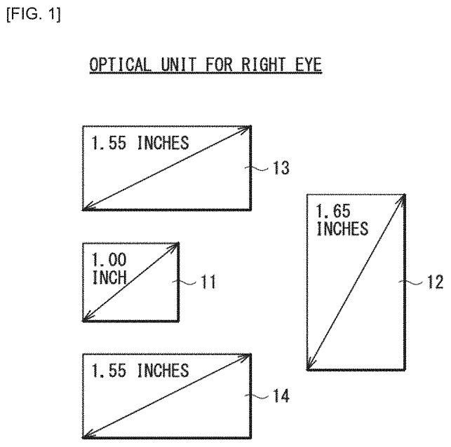

### 1. First Embodiment (FIGS. 1 to 14)

### 1.1 Configuration and Operation

### 1.2 Effects

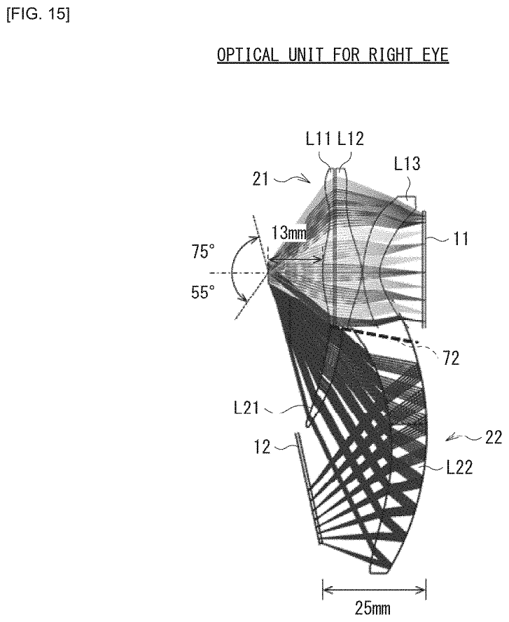

### 2. Second Embodiment (FIG. 15)

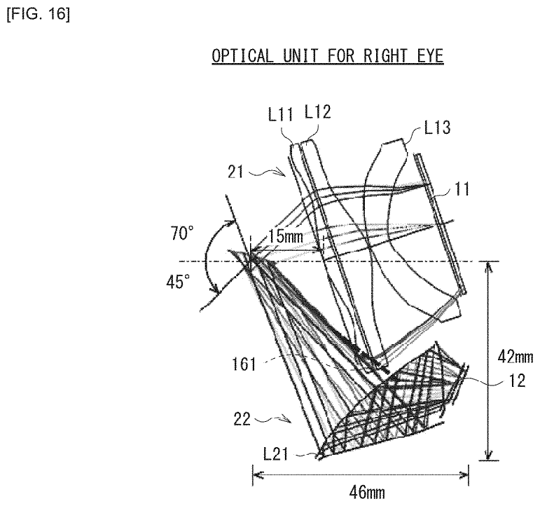

### 3. Third Embodiment (FIG. 16)

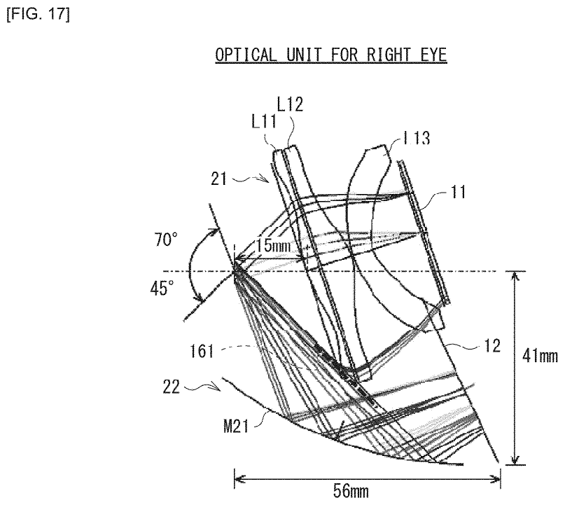

### 4. Fourth Embodiment (FIG. 17)

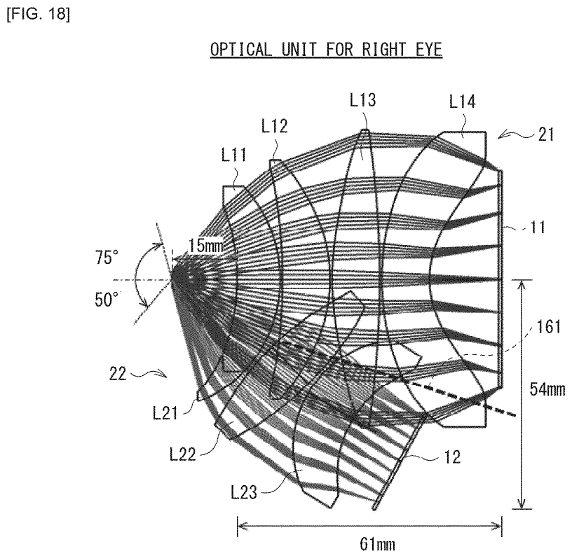

### 5. Fifth Embodiment (FIG. 18)

### 6. Another Embodiment

### 0. Overview

### 0.1 Comparative Example

In a case where an image forming element having a limited number of pixels is viewed by using an eyepiece optical system, the pixel count per angle is determined in general in accordance with a viewing angle. The resolution and the viewing angle thus have a trade-off relationship. Although there is also means for increasing an image forming element in area to increase the pixel count while keeping pixel density, this is not favorable because this increases the whole of the apparatus in size. A variety of techniques are reported (see PTLs 1 to 3 and NPTL 1) to resolve the trade-off relationship described above and achieve a reduction in apparatus size and weight. The variety of techniques include viewing one virtual image obtained by joining images with a plurality of image forming elements and a plurality of eyepiece optical systems. In addition, there is also a technique of increasing a viewing angle by using a single image forming element and a single eyepiece optical system (see PTL 4).

For example, a technique is known that uses two image forming elements for each of eyes to increase the viewing angle while suppressing an increase in virtual image display apparatus size and weight (see, for example, PTL 1).

Meanwhile, a technique is also known that achieves a compact optical design by using an eyepiece optical system divided into a plurality of small lenses including a free-form surface to view one image forming element for each of eyes to increase the viewing angle while keeping high resolution (see, for example, PTL 2).

In addition, a technique is also known that achieves a compact optical design by using two eyepiece optical systems each including a free-form surface to view two small and high-definition image forming elements for each of eyes to increase the viewing angle while keeping high resolution (see, for example, NPTL 1).

In addition, a technique is also known that increases only the resolution near the gazing point of a viewer by using a half mirror for the region of a portion of a virtual image having a wide visual field region outputted from a first image forming element and superimposing a virtual image having high resolution outputted from a second image forming element to obtain a virtual image display apparatus having high resolution and a wide viewing angle (see, for example, PTL 3).

The technique described in PTL 1 uses two image forming elements for each of eyes. A vertical field angle of at least about 100° is, however, necessary for an eyepiece optical system disposed right in front of a viewer to increase a sense of immersion. Further, a horizontal field angle of 90° (45° on the nose side) or more is also necessary. An image forming element of several inches or more is therefore necessary to achieve this viewing angle by using one eyepiece optical system including a Fresnel lens or the like. In recent years, liquid crystal displays and OLED (organic EL) displays each having high pixel density have been under development as image forming devices of several inches. Whichever display is used, a virtual image to be viewed has an angular resolution of 5 to 6 minutes of arc. This falls short of an angular resolution of 1 to 2 minutes of arc. Human eyes have an angular resolution of 1 to 2 minutes of arc. It is thus difficult to obtain a sufficient sense of immersion.

In the technique described in PTL 2, an eyepiece optical system divided into small lenses allows for an optical design corresponding to the characteristics of human eyes. Each of eyes, however, has only one image forming element. This requests an image forming device of several inches to achieve a wide viewing angle. As described above, PTL 2 also has a problem with insufficient resolution as with PTL 1. Further, a joint position of a virtual image is disposed to overlap with the front region in the visual field of a viewer. This increases the risk that the border between images is visually recognized or the risk that the physical border between adjacent small lenses is visually recognized.

The technique described in NPTL 1 includes two small and high-definition image forming elements for each of eyes. The size of each of the image forming elements is one inch. This is competitive price. Each eye, however, has a horizontal field angle of 92° and a vertical field angle of 75°. This makes it difficult to obtain a sufficient sense of immersion. To achieve a viewing angle of at least 100° or more, four or more image forming elements are necessary for each of eyes in consideration of symmetry. This causes higher manufacturing cost.

The technique described in PTL 3 uses a half mirror and superimposes a virtual image having high resolution. The technique described in PTL 3 thus has a configuration of great optical path length. As a viewing angle is increased, the volume of an eyepiece optical system extremely increases. In addition, the field angle region is narrow in which a high resolution output is obtained. This requests a display region to be dynamically driven in real time while detecting the line-of-sight direction of a viewer. This causes a large-scale sliding mechanism to be disposed in front of eyes and makes it difficult to achieve a reduction in virtual image display apparatus size and weight.

In addition, PTL 4 discloses a technique for a head-mounted display apparatus including an image forming element having a flat middle portion and a curved peripheral portion. The head-mounted display apparatus has a configuration in which the pixel size of the peripheral portion of the screen is greater than that of the middle portion of the screen. The technique described in PTL 4 uses a single image forming element and a single image forming element for each of eyes to increase the viewing angle. In the technique described in PTL 4, the middle portion and the peripheral portion of a single image forming element have to be different in pixel size and planar shape. This requests a special manufacturing method. Accordingly, the technique described in PTL 4 is disadvantageous in manufacturing cost.

As described above, it is difficult in general that a small and light-weighted head-mounted virtual image display apparatus achieves both high resolution and a wide viewing angle while suppressing the manufacturing cost.

Accordingly, it is desired to develop a relatively small and light-weighted head-mounted virtual image display apparatus and a virtual image display method each of which makes it possible to achieve high resolution and a wide viewing angle while suppressing the manufacturing cost and provide a viewer with comfortable wearability and a sense of immersion.

### 0.2 Overview of Head-Mounted Virtual Image Display Apparatus and Virtual Image Display Method According to Embodiment of the Present Disclosure

A head-mounted virtual image display apparatus according to an embodiment of the present disclosure includes a plurality of image forming elements that outputs a plurality of images and a plurality of eyepiece optical systems that is provided in association with the plurality of respective image forming elements and forms one virtual image as a whole from the plurality of images. The plurality of image forming elements includes a first high-definition and small image forming element that displays an image which is outputted to the front region in the visual field of a viewer and second to N-th (N represents an integer of 3 or more) image forming elements that are each lower than the first image forming element in resolution and each display an image which is outputted to a peripheral region in the visual field of the viewer. The plurality of eyepiece optical systems includes a first eyepiece optical system that is provided in association with the first image forming element and second to N-th eyepiece optical systems (other eyepiece optical systems) that are provided in association with the second to N-th image forming elements. The head-mounted virtual image display apparatus according to the embodiment is characterized in that a first image displayed by the first image forming element is not a subset of any of second to N-th images displayed by the second to N-th image forming elements. The head-mounted virtual image display apparatus according to the embodiment is configured to have a viewer to view the first to N-th images as joined into one virtual image via the first to N-th eyepiece optical systems that are respectively appropriate for the first to N-th images. The first to N-th images are displayed by the first to N-th image forming elements.

In such a configuration, the first high-definition image forming element is used for a stable gazing field to output a virtual image having high resolution. In the stable gazing field, a human exhibits an excellent visual function. The second to N-th image forming elements each of which is relatively low in manufacturing cost are used for a peripheral visual field to output virtual images that are lower than that of the first image forming element in resolution. In the peripheral visual field, a human exhibits low information discrimination capability. This makes it possible to prevent the virtual image display apparatus from having unnecessarily too high performance and optimize the balance between resolution and manufacturing cost.

In addition, the number of second to N-th image forming elements and the number of second to N-th eyepiece optical systems and the disposition of second to N-th image forming elements and the disposition of second to N-th eyepiece optical systems are adjusted in accordance with a viewing angle requested from the virtual image display apparatus. This makes it possible to relatively easily achieve a wide viewing angle.

In addition, the first image forming element disposed right in front of a viewer is small and the field angle of a virtual image is also limited to the stable gazing field. This allows the corresponding first eyepiece optical system to have a relatively compact optical design. Further, to make an optical design for a wide viewing angle, it is easier to secure optical performance by using a plurality of divided eyepiece optical systems rather than a single eyepiece optical system and it is also possible to reduce the respective eyepiece optical systems in height. As a result, it is thus possible to achieve a reduction in virtual image display apparatus size and weight as a whole.

In the head-mounted virtual image display apparatus according to the embodiment, for example, the first eyepiece optical system outputs a virtual image having 60° or more and 120° or less as the horizontal field angle and 45° or more and 100° or less as the vertical field angle. As a result, a virtual image outputted from the first eyepiece optical system and virtual images outputted from the second to N-th eyepiece optical systems are joined together in a region that transitions to the peripheral visual field from the stable gazing field. This makes it possible to avoid the risk that the border between images is visually recognized. Further, such a configuration also alleviates the risk that the physical border between the first eyepiece optical system and the second to N-th eyepiece optical systems which is adjacent to the first eyepiece optical system is visually recognized.

For example, the first image forming element of the head-mounted virtual image display apparatus according to the embodiment has a resolution of 2000 ppi or more and the second to N-th image forming elements each have a resolution of less than 2000 ppi. This makes it possible to output a virtual image to at least the stable gazing field with an angular resolution of 2 minutes of arc or less. In the stable gazing field, a human exhibits an excellent visual function. As a result, it is possible to view a virtual image that is equal to or more than an angular resolution of 1 to 2 minutes of arc. Human eyes have an angular resolution of 1 to 2 minutes of arc. This allows a viewer to have a sufficient sense of resolution.

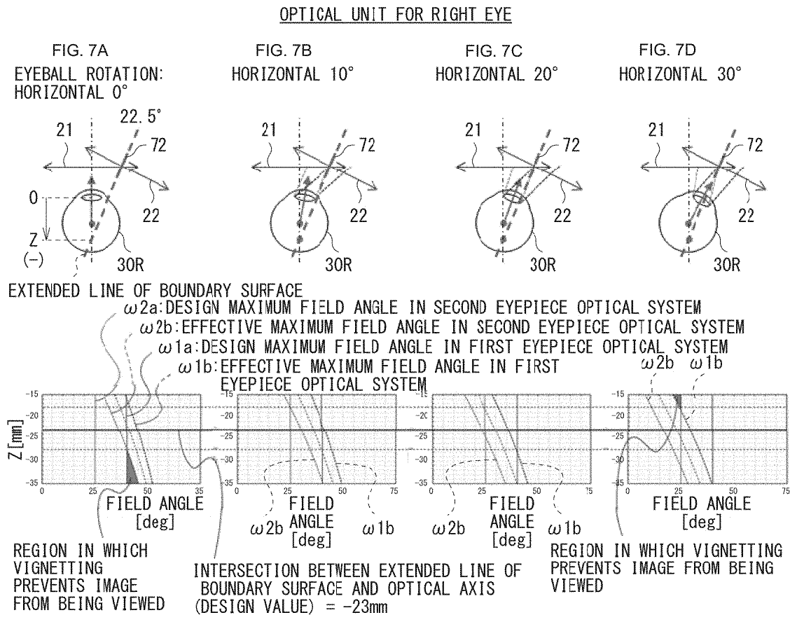

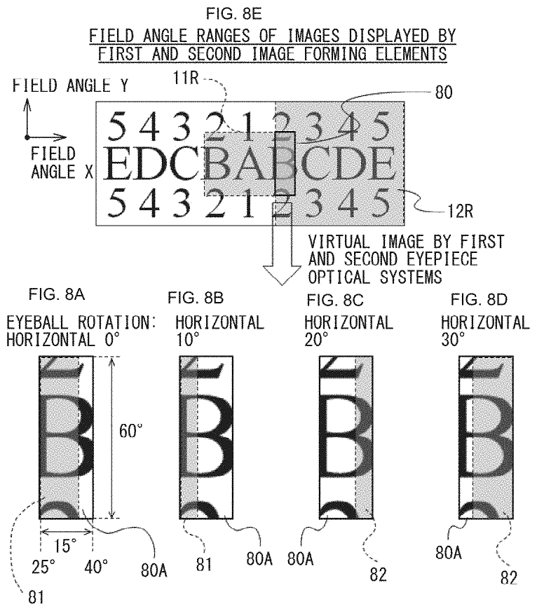

More desirably, in the first to N-th eyepiece optical systems, the position of the boundary surface between two given adjacent eyepiece optical systems is designed to join two given adjacent virtual images that are outputted from the respective eyepiece optical systems to cause two given adjacent virtual images to constantly have overlapping regions even in the presence of eyeball rotation accompanying the line-of-sight movement of a viewer in the stable gazing field (see a first embodiment, FIGS. 7 to 8, and the like described below). As a result, it is possible to join virtual images together with no gap even in a case where a viewer moves the line of sight. This makes it possible to alleviate the risk that the border between images is visually recognized.

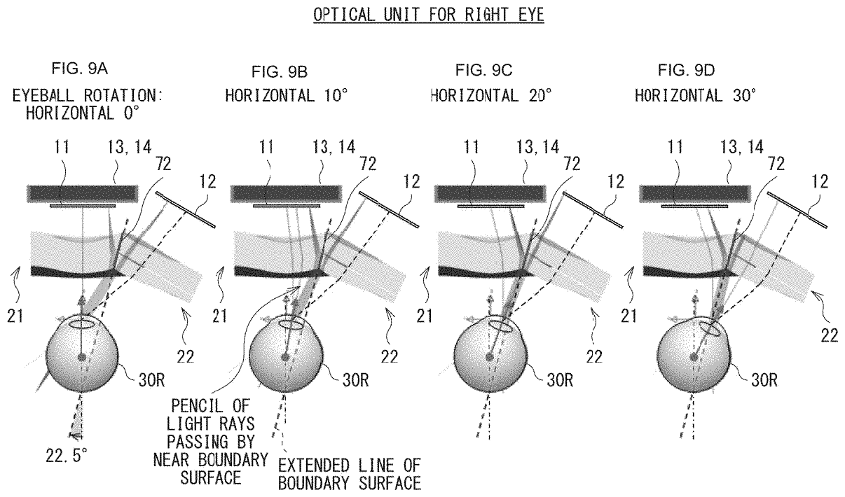

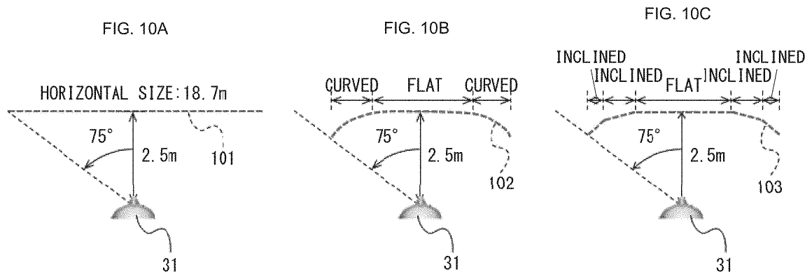

More desirably, in the first to N-th eyepiece optical systems, the inclination angle of the boundary surface between two given adjacent eyepiece optical systems is designed to reduce (suppress) the vignetting of a pencil of light rays passing near the boundary surface even in the presence of eyeball rotation accompanying the line-of-sight movement of a viewer in the stable gazing field (see the first embodiment, FIG. 9, and the like described below). As a result, it is possible to suppress a light amount reduction at the joint position between two given adjacent virtual images even in a case where a viewer moves the line of sight. This makes it possible to alleviate the risk that the border between images is visually recognized.

The first to N-th eyepiece optical systems may be designed to form a smoothly curved virtual image surface as a whole to cover a viewer's field of vision. Alternatively, while each of the eyepiece optical systems forms a flat virtual image surface, eyepiece optical systems disposed closer to the periphery may be designed to form more inclined virtual image surfaces, thereby forming a discretely curved virtual image surface as a whole to cover a viewer's field of vision (see the first embodiment and FIG. 10 described below). As a result, a viewer experiences video as surrounding the viewer. This allows the viewer to have a further sense of immersion.

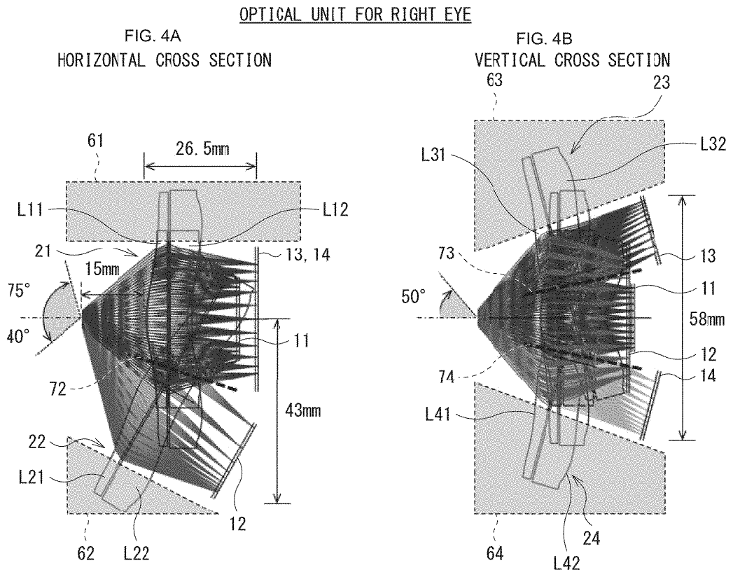

At least one eyepiece optical system of the first to N-th eyepiece optical systems may include at least one Fresnel lens (see the first to fourth embodiments, FIG. 4, and the like described below). Such a configuration makes it possible to reduce an eyepiece optical system in height by using a Fresnel lens. As a result, it is thus possible to achieve a reduction in virtual image display apparatus size and weight as a whole.

The second to N-th eyepiece optical systems may be each designed as an eyepiece optical system that has a different optical scheme from that of the first eyepiece optical system (see the second to fourth embodiments and FIGS. 15 to 17 described below).

For example, the second to N-th eyepiece optical systems may be each designed as an eyepiece optical system of an optical scheme in which a free-form surface prism or a free-form surface mirror is included. Such a configuration makes it possible to select the optimum optical scheme in accordance with optical performance necessary for the peripheral visual field. In addition, a flexible optical design is possible such as securing sufficient space in front of eyes (space from the face of a viewer to the optical surface that is the closest to the eyes) to allow a viewer to wear the virtual image display apparatus with glasses on and satisfying a requirement caused by a housing design.

The first to N-th eyepiece optical systems may be designed to cause at least the surface positioned the closest to the eye side of a viewer to be shared as the same lens surface between the first to N-th respective eyepiece optical systems (see the fifth embodiment and FIG. 18 described below). The head-mounted virtual image display apparatus according to the embodiment is designed to have a region in which two given adjacent virtual images of first to N-th virtual images formed by the first to N-th eyepiece optical systems overlap. The head-mounted virtual image display apparatus according to the embodiment partially has superimposed regions in each of which two given adjacent image forming elements display the same image. Such a configuration makes it possible to reduce the superimposed regions. As a result, it is thus possible to increase the use efficiency of the pixels of all of the image forming elements. Further, sharing the lens surface on the eye side also reduces the risk that the physical border between two given adjacent eyepiece optical systems is visually recognized.

The head-mounted virtual image display apparatus according to the embodiment of the present disclosure may further include a sliding mechanism that makes it possible to control the distance (virtual image distance) from an observer to a virtual image surface by each of a plurality of eyepiece optical systems (see the first embodiment and FIG. 12 described below). The sliding mechanism may make it possible to control the virtual image distance by each of the eyepiece optical systems by sliding the position of a component such as a lens and a lens group included in each of the first to N-th eyepiece optical systems and the position of the image forming element corresponding to each of the eyepiece optical systems.

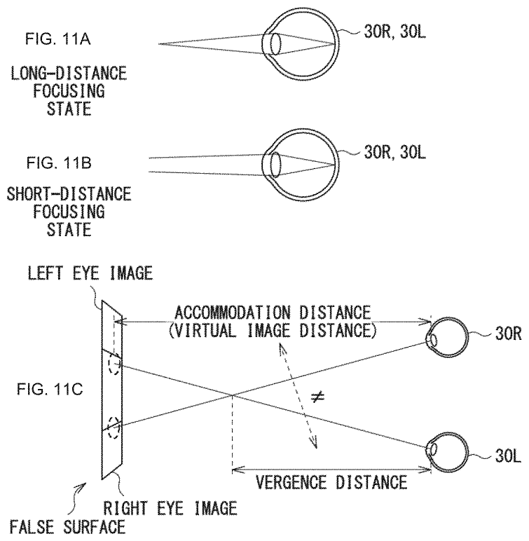

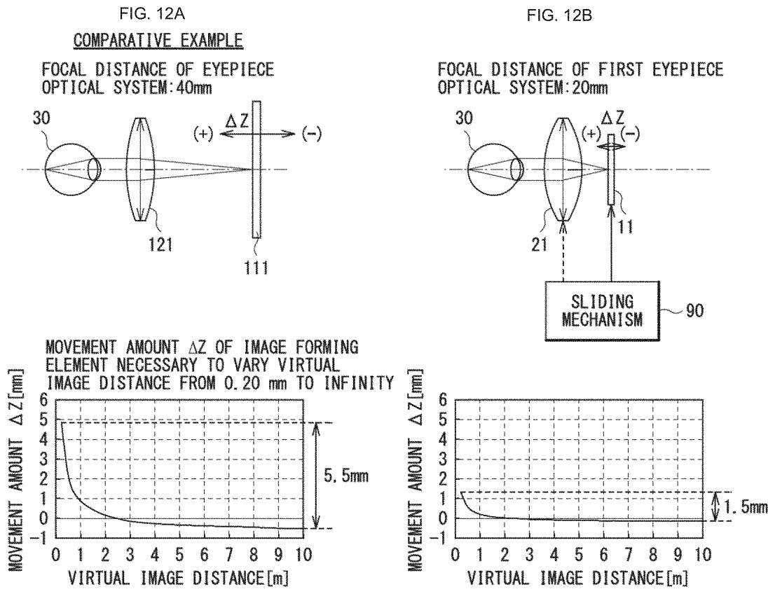

For example, the first to N-th eyepiece optical systems are designed to control the virtual image distance from 20 mm in front of a viewer to the infinity as the distance from the viewer. As a result, the “mismatch problem with vergence distance and accommodation distance” (see the first embodiment and FIG. 11 described below) of a conventional virtual image viewing apparatus is solved and a viewer feels less uncomfortable or less sick in viewing, for example.

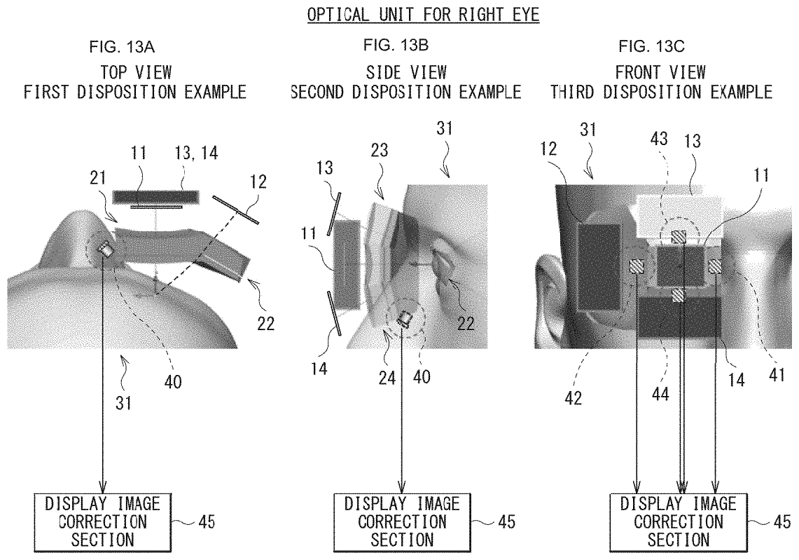

In a virtual image display method according to an embodiment of the present disclosure, a correction process is performed on images that is displayed on the respective image forming elements by taking into consideration the optical characteristics of the first to N-th eyepiece optical systems such as aberration and peripheral darkening, darkening caused by vignetting of a pencil of light rays that is geometrically determined from the pupil position and the pupil diameter of a viewer and the position and the inclination angle of a boundary surface in the eyepiece optical systems, further the light emission characteristics of the first to N-th image forming elements such as light distribution, chromaticity, and spectra, and the like (see the first embodiment, FIG. 13, and the like described below).

Such a method makes it possible to seamlessly join a plurality of virtual images that is outputted from the first to N-th eyepiece optical systems and alleviate the risk that the borders between a plurality of images are visually recognized.

More desirably, the correction process on images that are displayed on the first to N-th image forming elements is adjusted in real time in accordance with of eyeball rotation accompanying the line-of-sight movement of a viewer while the line-of-sight direction of the viewer is detected. The correction process of seamlessly joining a plurality of virtual images varies in accordance with the state of eyeball rotation. Such a method thus makes it possible to alleviate the risk that the border between a plurality of images is visually recognized even in a case where a viewer moves the line of sight.

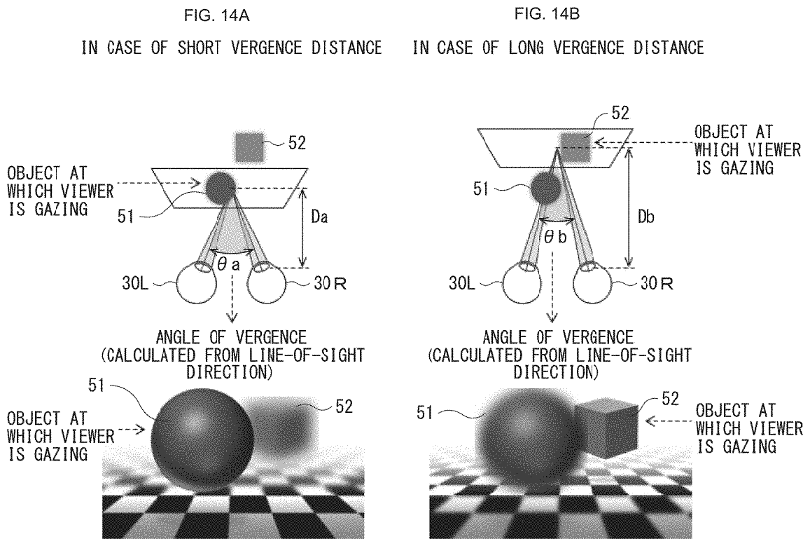

In addition, in the virtual image display method according to the embodiment, the virtual image distance from an observer to each of virtual image surfaces by the first to N-th eyepiece optical systems may be controlled in accordance with a viewer's angle of vergence by sliding the position of a component in each of the first to N-th eyepiece optical systems or the position of each of the first to N-th image forming elements with a sliding mechanism while the line-of-sight direction of the viewer is detected. In addition, images that are displayed on the first to N-th image forming elements may be adjusted at the display positions corresponding to the magnification of the first to N-th eyepiece optical systems and an observer's angle of vergence and a display object that is out of the vergence distance and the viewer is not gazing at may be corrected to be subjected to a blur process in conjunction with the operation of the sliding mechanism (see the first embodiment, FIG. 14, and the like described below).

Such a method solves the “mismatch problem with vergence distance and accommodation distance” of a typical virtual image display apparatus and makes a viewer feel less uncomfortable or less sick in viewing, for example. In addition, such a method makes it possible to seamlessly join together the first to N-th virtual images that are outputted from the first to N-th eyepiece optical systems and output a virtual image having a natural sense of depth.

The following describes the specific first to fifth embodiments of the head-mounted virtual image display apparatus and the virtual image display method according to the respective embodiments of the present disclosure described above in detail with reference to the drawings where appropriate. It is to be noted that, in this specification and the drawings, components that have substantially the same functional configuration are denoted with the same section numbers and repeated description is thus omitted.

### 1. First Embodiment

### 1.1 Configuration and Operation

### (Overview of Head-Mounted Virtual Image Display Apparatus)

A head-mounted virtual image display apparatus according to the first embodiment includes an optical unit for a left eye 30L and an optical unit for a right eye 30R. In the first embodiment and the second to fifth embodiments described below, a configuration of the optical unit for the right eye 30R is primarily described as an example. A configuration of the optical unit for the left eye 30L is, however, basically the same as that of the optical unit for the right eye 30R.

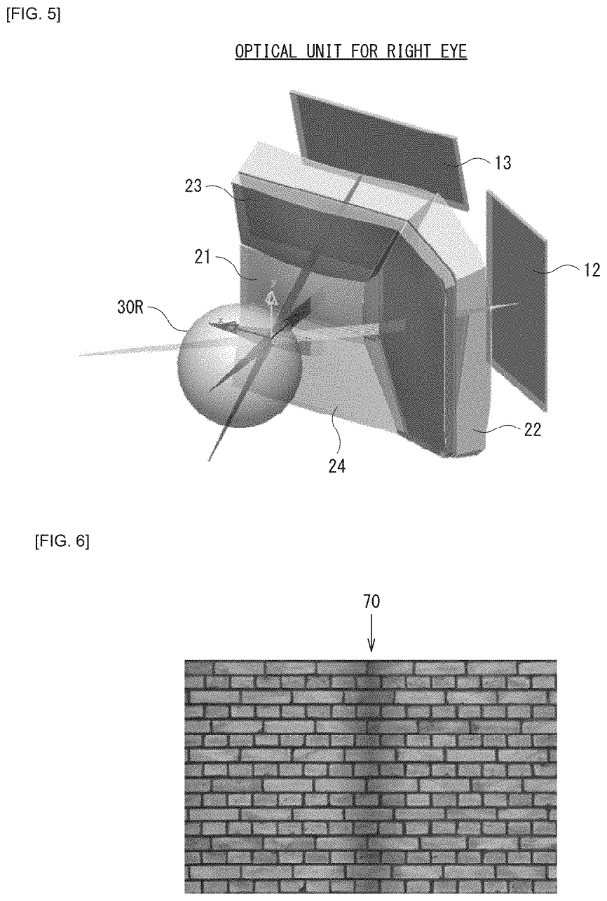

In the head-mounted virtual image display apparatus according to the first embodiment, the optical unit for the left eye 30L and the optical unit for the right eye 30R each include a plurality of image forming elements including first to fourth image forming elements 11 to 14 (see FIG. 1 and the like described below) and a plurality of eyepiece optical systems including first to fourth eyepiece optical systems 21 to 24 (see FIGS. 4 and 5 and the like described below) corresponding to the first to fourth image forming elements 11 to 14.

### Configuration Example of Image Forming Elements

FIG. 1 illustrates a disposition example and a configuration example of the first to fourth image forming elements 11 to 14 included in the optical unit for the right eye 30R in the head-mounted virtual image display apparatus according to the first embodiment. It is to be noted that FIG. 1 illustrates the respective image forming elements disposed on the same plane for the sake of explanation, but the respective image forming elements are not actually disposed on the same plane. The respective image forming elements are disposed to be appropriately inclined in three-dimensional space (see FIG. 5 and the like described below).

The first image forming element 11 is a high-definition and small image forming element. The first image forming element 11 displays an image that is outputted to the front region in the visual field of a viewer. The first image forming element 11 has, for example, a pixel pitch of 7.8 μm, a diagonal size of 1 inch, a horizontal pixel count of 2500 pixels, and a vertical pixel count of 2080 pixels. The first image forming element 11 is, for example, M-OLED

### (Micro Organic Light Emitting Diode).

The second image forming element 12 is disposed on the right side of the first image forming element 11. The second image forming element 12 displays an image that is outputted to the right peripheral region in the visual field of a viewer. The pixel pitch of the second image forming element 12 is greater than that of the first image forming element 11. The second image forming element 12 has, for example, a pixel pitch of 65.25 μm and a diagonal size of 1.65 inches. In addition, the second image forming element 12 has, for example, a horizontal pixel count of 300 pixels and a vertical pixel count of 550 pixels. The second image forming element 12 is, for example, LTPS (Low Temperature Polycrystalline Silicon)-OLED. It is to be noted that the second image forming element 12 is disposed on the left side of the first image forming element 11 in a case of the optical unit for the left eye 30L. The second image forming element 12 displays an image that is outputted to the left peripheral region in the visual field of a viewer.

The third image forming element 13 is disposed on the upper side of the first image forming element 11. The third image forming element 13 displays an image that is outputted to the upper peripheral region in the visual field of a viewer. The fourth image forming element 14 is disposed on the lower side of the first image forming element 11. The fourth image forming element 14 displays an image that is outputted to the lower peripheral region in the visual field of a viewer. The pixel pitch of each of the third and fourth image forming elements 13 and 14 is greater than that of the first image forming element 11. The third and fourth image forming elements 13 and 14 each have, for example, a pixel pitch of 65.25 μm. The third and fourth image forming elements 13 and 14 each have, for example, a diagonal size of 1.55 inches. The third and fourth image forming elements 13 and 14 each have, for example, a horizontal pixel count of 525 pixels and a vertical pixel count of 260 pixels. Each of the third and fourth image forming elements 13 and 14 is, for example, LTPS-OLED.

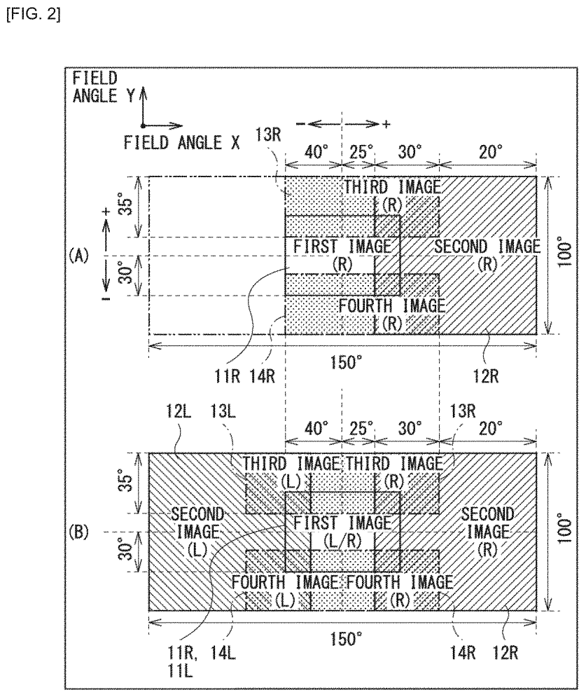

FIG. 2 illustrates an example of a field angle region of each of a plurality of images. The plurality of images is separately displayed by all of the image forming elements included in each of the optical units for the right eye 30R and the left eye 30L for the whole of a virtual image that is outputted from the head-mounted virtual image display apparatus according to the first embodiment. In FIG. 2, (A) illustrates the respective field angle regions of first to fourth images 11R, 12R, 13R, and 14R displayed by the optical unit for the right eye 30R. In FIG. 2, (B) illustrates the respective field angle regions of images including the first to fourth images 11R, 12R, 13R, and 14R displayed by the optical unit for the right eye 30R and first to fourth images 11L, 12L, 13L, and 14L displayed by the optical unit for the left eye 30L. It is to be noted that FIG. 2 assumes that the field angle region of the whole image displayed by the optical unit for the right eye 30R and the optical unit for the left eye 30L has a horizontal field angle (field angle X) of 0° and a vertical field angle (field angle Y) of 0° at the central position. In addition, it is assumed that the right side is a +direction and the left side is a −direction with respect to the horizontal field angle. In addition, it is assumed that the upper side is a +direction and the lower side is a −direction with respect to the vertical field angle. This also holds true for the other following diagrams.

In the optical unit for the right eye 30R, the field angle region of the first image 11R displayed by the first image forming element 11 has, for example, a horizontal field angle within a range of −40° or more and 40° or less and a vertical field angle within a range of −30° or more and 30° or less. In addition, in the optical unit for the right eye 30R, the field angle region of the second image 12R displayed by the second image forming element 12 has a horizontal field angle within a range of 25° or more and 75° or less and a vertical field angle within a range of −50° or more and 50° or less. In addition, in the optical unit for the right eye 30R, the field angle region of the third image 13R displayed by the third image forming element 13 has a horizontal field angle within a range of −40° or more and 55° or less and a vertical field angle within a range of 15° or more and 50° or less. In addition, in the optical unit for the right eye 30R, the field angle region of the fourth image 14R displayed by the fourth image forming element 14 has a horizontal field angle within a range of −40° or more and 55° or less and a vertical field angle within a range of −50° or more and −15° or less.

In addition, in the optical unit for the left eye 30L, the field angle region of the first image 11L that is displayed by the first image forming element 11 has a horizontal field angle within a range of −40° or more and 40° or less and a vertical field angle within a range of −30° or more and 30° or less. In addition, in the optical unit for the left eye 30L, the field angle region of the second image 12L that is displayed by the second image forming element 12 has a horizontal field angle within a range of −75° or more and −25° or less and a vertical field angle within a range of −50° or more and 50° or less. In addition, in the optical unit for the left eye 30L, the field angle region of the third image 13L displayed by the third image forming element 13 has a horizontal field angle within a range of −55° or more and 40° or less and a vertical field angle within a range of 15° or more and 50° or less. In addition, in the optical unit for the left eye 30L, the field angle region of the fourth image 14L displayed by the fourth image forming element 14 has a horizontal field angle within a range of −40° or more and 55° or less and a vertical field angle within a range of −50° or more and −15° or less.

The first image forming element 11 in the optical unit for the right eye 30R and the first image forming element 11 in the optical unit for the left eye 30L display equal field angle regions. In addition, the optical units for the left eye 30L and the right eye 30R superimpose field angle regions each having a horizontal field angle of −40° or more and 40° or less and a vertical field angle of −50° or more and 50° or less. These field angle regions are effective in providing a viewer with depth perception by using parallax images. Further, two given adjacent images are disposed to have superimposed regions each having a field angle of at least 15° or more.

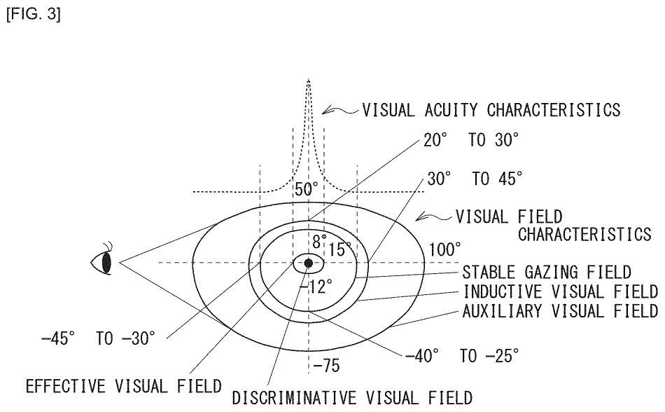

FIG. 3 illustrates an overview of the visual field characteristics of human eyes. In general, it is said that humans are able to see a visual field having a horizontal range of about 200° and a vertical range of about 125°. Humans are not, however, able to simultaneously identify pieces of information regarding all of these visual field regions. As illustrated in FIG. 3, humans distribute functions to the respective visual field regions.

There is a region referred to as discriminative visual field in which humans exhibits an excellent visual function in the central portion of the visual field, that is, the line-of-sight direction. This angle region has a range of ±2.5°. In addition, the region having a horizontal range of ±15° and a vertical range of −12° or more and 8° or less is referred to as effective visual field. Humans are able to instantly identify information just by moving the eyes. Different between individuals, humans each have the region having a horizontal range of −45° to −30° or more and 30° to 45° or less and a vertical range of −40° to −25° or more and 20° to 30° or less outside the effective visual field. This region is referred to as stable gazing field. Humans are each able to effectively identify information by a line-of-sight movement achieved by moving the eyes or moving the head. Further, the peripheral visual field outside the stable gazing field includes regions referred to as inductive visual field and auxiliary visual field. In any of them, humans exhibit low information discrimination capability.

If the visual field characteristics illustrated in FIG. 3 are taken into consideration, the joint position between two given adjacent images separately displayed by the respective image forming elements is excluded from the stable gazing field, thereby making it possible to avoid the risk that the border between the two given adjacent images is visually recognized. For example, if a difference between individuals is taken into consideration, it is preferable in general that the joint position between two given adjacent images fall within a region having ±40° or more as the horizontal field angle and ±30° or more as the vertical field angle. In the first embodiment, as illustrated in FIG. 2, a field angle region that is displayed by the first image forming element 11 falls within a range of −40° or more and 40° or less as the horizontal field angle and a range of −30° or more and 30° or less as the vertical field angle. If a difference between individuals is taken into consideration, it is thus possible in general to consider that the joint position is disposed in a region that transitions from the stable gazing field to the peripheral visual field.

### Configuration Example of Eyepiece Optical System

FIG. 4 illustrates a configuration example of the first to fourth eyepiece optical systems 21 to 24 included in the optical unit for the right eye 30R in the head-mounted virtual image display apparatus according to the first embodiment along with optical paths. In FIG. 4, (A) illustrates a horizontal cross section and (B) illustrates a vertical cross section. The first to fourth eyepiece optical systems 21 to 24 are designed to make it possible to output field angle regions that are separately displayed by the respective image forming elements corresponding to the first to fourth eyepiece optical systems 21 to 24. The optical unit for the right eye 30R outputs a virtual image as a whole. The virtual image has a horizontal field angle within a range of −40° or more and 75° or less and a vertical field angle within a range of −50° or more and 50° or less.

The first eyepiece optical system 21 includes a first L1 lens L11 and a first L2 lens L12. The second eyepiece optical system 22 includes a second L1 lens L21 and a second L2 lens L22. The third eyepiece optical system 23 includes a third L1 lens L31 and a third L2 lens L32. The fourth eyepiece optical system 24 includes a fourth L1 lens L41 and a fourth L2 lens L42.

There is a boundary surface 72 between the first eyepiece optical system 21 and the second eyepiece optical system 22. There is a boundary surface 73 between the first eyepiece optical system 21 and the third eyepiece optical system 23. There is a boundary surface 74 between the first eyepiece optical system 21 and the fourth eyepiece optical system 22.

It is to be noted that regions outside the effective diameters of the respective lenses may be cut-off regions 61 to 64 of the lenses.

In the first embodiment, each of the first to fourth eyepiece optical systems is optically designed to adopt a Fresnel lens as each of the opposed surfaces of the L1 lens and the L2 lens. This makes it possible to achieve a reduction in optical unit height and weight and further achieve a reduction in apparatus height and weight as a whole as compared with an optical design in which only a standard spherical lens and a standard aspherical lens are adopted.

FIG. 5 illustrates a perspective configuration example of the first to fourth eyepiece optical systems 21 to 24 included in the optical unit for the right eye 30R in the head-mounted virtual image display apparatus according to the first embodiment. The first to fourth adjacent eyepiece optical systems are arranged to have appropriate boundary surfaces. This forms ridge lines on the lens surfaces. In the first embodiment, as illustrated in FIG. 2, the joint position between two given adjacent images is disposed in a region that transitions from the stable gazing field to the peripheral visual field. This also alleviates the risk that the ridge line is visually recognized.

FIG. 6 illustrates an example of the visually recognized state of an image viewed by two eyepiece optical systems that are adjacent in the horizontal direction. As illustrated in FIG. 6, if an image to be viewed has a missing portion or a light amount reduction at a joint position 70 between respective virtual images formed by two eyepiece optical systems that are adjacent in the horizontal direction, the border between the images may be visually recognized. To avoid this risk, it is necessary to design eyepiece optical systems to join together two given adjacent images with sufficient superimposed regions left and reduce the vignetting of a pencil of light rays. The following describes a procedure of the design in detail with reference to FIGS. 7 to 9.

### Design Examples of Position of Boundary Surface Between Two Given Adjacent Eyepiece Optical Systems

FIG. 7 illustrates an example of a procedure of designing the position of the boundary surface between two given eyepiece optical systems that are adjacent in the horizontal direction in the head-mounted virtual image display apparatus according to the first embodiment. FIG. 7 illustrates, as an example, the first and second eyepiece optical systems 21 and 22 included in the optical unit for the right eye 30R as two given eyepiece optical systems that are adjacent in the horizontal direction.

In FIG. 7, (A) illustrates a field angle range that is viewed in a case where a viewer is gazing at the front with a distance of 15 mm from a pupil surface of the viewer to the first eyepiece optical system 21 and a pupil diameter of 4 mm (in a case where an eyeball has a rotation amount of 0°). In the graphs of the lower parts of (A) to (D) of FIG. 7, the vertical axes each represent an intersection Z between an extended line of the boundary surface 72 and an optical axis with the position of the pupil surface defined as Z=0. The horizontal axes each represent the field angle range viewed at the intersection Z. In the graphs of the lower parts of (A) to (D) of FIG. 7, ω1a represents the maximum field angle (design value) for the first eyepiece optical system 21, ω1b represents the maximum field angle (effective value) for the first eyepiece optical system 21, ω2a represents the maximum field angle (design value) for the second eyepiece optical system 22, and ω2b represents the maximum field angle (effective value) for the second eyepiece optical system 22. In the graph of the lower part of (A) of FIG. 7, the design maximum field angle cola for the first eyepiece optical system 21 has a value of 40°. This value is the upper limit value of the field angle defined by the optical design. The design maximum field angle ω2a for the second eyepiece optical system 22 is 25°. This value is the lower limit value of the field angle designed by the optical design of the second eyepiece optical system 22. These field angles thus overlap by 15°. In addition, the effective maximum field angle ω1b for the first eyepiece optical system 21 is the upper limit value of the effective field angle for the first eyepiece optical system 21. The upper limit value is determined by the occurrence of vignetting in a pencil of light rays according to the position of the boundary surface 72. The effective maximum field angle ω2b for the second eyepiece optical system 22 is the lower limit value of the effective field angle for the second eyepiece optical system 22. The lower limit value is determined in a similar way. As a result, in a case where the intersection Z between the extended line of the boundary surface 72 and the optical axis is selected be smaller than −27 mm, a filled field angle region in a graph is not viewed. An image has a missing portion at the joint position between virtual images. In FIG. 7, (B) to (D) respectively illustrate field angle ranges viewed by using the first and second eyepiece optical systems 21 and 22 in a case where an eyeball rotates in the horizontal direction by 10°, 20°, and 30°. In (D) of FIG. 7, in a case where the intersection Z is selected to be greater than −18 mm, an image has a missing portion in the filled field angle region in the graph. To join images with no missing portion even in the presence of eyeball rotation, it is thus necessary to select the intersection Z within a range of −27 mm or more and −18 mm or less. In the design of the first embodiment, the position corresponding to the intersection Z=−23 mm is used as the position of the boundary surface 72.

It is to be noted that the design of FIG. 7 uses the boundary surface 72 as one flat surface, but boundary surfaces may be set that are different between lenses in accordance with optical paths.

FIG. 8 schematically illustrates an example of field angle ranges of virtual images viewed by using the first and second eyepiece optical systems 21 and 22. The field angle ranges correspond to superimposed regions 80 of the first and second images 11R and 12R that are displayed by the first and second image forming elements 11 and 12 in the head-mounted virtual image display apparatus according to the first embodiment. In FIG. 8, (E) schematically illustrates the field angle ranges of the first and second images 11R and 12R that are displayed by the first and second image forming elements 11 and 12. The first and second images 11R and 12R have the superimposed regions 80. In FIG. 8, (A) to (D) respectively illustrate the field angle ranges of virtual images viewed by the first and second eyepiece optical systems 21 and 22 in a case where an eyeball rotates in the horizontal direction by 0°, 10°, 20°, and 30°. In (A) and (B) of FIG. 8, the regions that are shaded represent a field angle region 81 of a virtual image viewed by only the first eyepiece optical system 21 (first image 11R by only the first image forming element 11). The regions that are not shaded represent a field angle region 80A in which virtual images that are outputted from the first eyepiece optical system 21 and the second eyepiece optical system 22 superimposed and viewed. In (C) and (D) of FIG. 8, the regions that are shaded represent a field angle region 82 of a virtual image viewed by only the second eyepiece optical system 22 (second image 12R by only the second image forming element 12). The regions that are not shaded represent the field angle region 80A in which virtual images that are outputted from the first eyepiece optical system 21 and the second eyepiece optical system 22 superimposed and viewed. In this way, the position of the boundary surface 72 between the first eyepiece optical system 21 and the second eyepiece optical system 22 is designed to join two adjacent virtual images that are outputted from the first eyepiece optical system 21 and the second eyepiece optical system 22 with no gap while causing the two adjacent virtual images to constantly have overlapping regions in spite of the line-of-sight movement of a viewer (even in the presence of eyeball rotation).

It is to be noted that the designs of the position of the boundary surface 72 between two eyepiece optical systems which are adjacent in the horizontal direction have been described so far with reference to FIGS. 7 and 8 by taking eyeball rotation in the horizontal direction into consideration, but similar designs are also applicable to a boundary surface in the vertical direction.

### Design Examples of Inclination Angle of Boundary Surface Between Two Given Adjacent Eyepiece Optical Systems

FIG. 9 illustrates an example of a procedure of designing the inclination angle of the boundary surface between two given eyepiece optical systems that are adjacent in the horizontal direction in the head-mounted virtual image display apparatus according to the first embodiment. FIG. 9 illustrates, as an example, the first and second eyepiece optical systems 21 and 22 included in the optical unit for the right eye 30R as two given eyepiece optical systems that are adjacent in the horizontal direction.

In FIG. 9, (A) to (D) respectively illustrate optical paths obtained by reversely tracking a pencil of light rays passing by near the boundary surface 72 between the first and second eyepiece optical systems 21 and 22 from the eye side (right eye 30R side) in a case where an eyeball rotates in the horizontal direction by 0°, 10°, 20°, and 30°. The dashed lines illustrated in (A) to (D) of FIG. 9 are straight lines obtained by extending the boundary surface 72. In a case where light rays are tacked from the eye side, a light ray intersecting with this boundary surface 72 becomes stray light after coming to the lens surface that is the closest to the eye side and being refracted. This brings about a light amount reduction caused by the vignetting of a pencil of light rays. This causes the images at the joint position to be darkened. Further, as illustrated in (A) to (D) of FIG. 9, the positional relationship varies between the boundary surface 72 and the pupil surface in accordance with eyeball rotation. This varies the angle of a pencil of light rays passing by near the boundary surface 72 and the pencil of light rays intersects with the boundary surface 72 at a different position. It is thus necessary to select the inclination angle of the boundary surface 72 to reduce the vignetting of a pencil of light rays on the boundary surface 72 even in the presence of eyeball rotation. In the design of the first embodiment, the boundary surface has an inclination angle of 22.5°.

It is to be noted that the design of FIG. 9 uses the boundary surface 72 as one flat surface, but boundary surfaces may be set that have different inclination angles between lenses in accordance with optical paths.

In addition, to reduce the vignetting of a pencil of light rays, it is desirable that a lens end surface in contact with boundary surface 72 have less surface area. The design in which a Fresnel lens is used is superior because it is easy to reduce a lens in height as with the first embodiment.

Further, as the boundary surface between two given adjacent eyepiece optical systems, the individually formed lenses may be separately grasped or bonded and fixed. Alternatively, the lenses may be integrally formed with the lens surfaces discontinuously shaped. In a case where individually formed lenses are used, the lens end surfaces on the boundary surface may be subjected to a sand blasting process or a blacking-out process to prevent stray light. A light-shielding sheet may be inserted to the boundary surface or a light-shielding mask may be added at an effective position. In contrast, in a case where stray light does not take a path leading into an eye, no countermeasures have to be particularly taken.

It is to be noted that the designs of the inclination angle of the boundary surface between two given eyepiece optical systems which are adjacent in the horizontal direction have been described so far with reference to FIG. 9 by taking eyeball rotation in the horizontal direction into consideration, but similar designs are also applicable to a boundary surface in the vertical direction.

### Design Examples of Virtual Image Surfaces Formed by Plurality of Eyepiece Optical Systems

FIG. 10 illustrates design examples of a virtual image surface that is outputted from a head-mounted virtual image display apparatus. In FIG. 10, (A) illustrates a design example in which virtual image surfaces that are outputted from a plurality of respective eyepiece optical systems included in the virtual image display apparatus form a single flat surface. In a case where the horizontal field angle falls within a range of ±75° and the virtual image distance is 2.5 m, a viewer 31 views a virtual image surface 101 having a width of 18.7 m in the horizontal direction. In FIG. 10, (B) illustrates a design example in which virtual image surfaces that are outputted from the respective eyepiece optical systems form a flat surface in the front region, but form curved surfaces in the peripheral regions. The viewer 31 views a smooth virtual image surface 102 that covers the field of vision, thereby obtaining a further sense of immersion. In FIG. 10, (C) illustrates a design example in which virtual image surfaces that are outputted from the respective eyepiece optical systems are flat surfaces, but eyepiece optical systems disposed closer to the periphery outputs more inclined virtual image surfaces. The viewer 31 views a discrete virtual image surface 103 that covers the field of vision. The head-mounted virtual image display apparatus according to the first embodiment has the respective eyepiece optical systems designed on the basis of the design example illustrated in (C) of FIG. 10. A virtual image surface that is outputted from the second eyepiece optical system 22 is inclined by 30° in the horizontal direction as compared with a virtual image surface that is outputted from the first eyepiece optical system 21.

It is to be noted that the designs of virtual image surfaces in the horizontal direction have been described so far with reference to FIG. 10. Similar designs are also applicable in the vertical direction.

### Control Example of Virtual Image Distance

FIG. 11 illustrates an overview of the “mismatch problem with vergence distance and accommodation distance” in a conventional head-mounted virtual image display apparatus having constant virtual image distance. (A) of FIG. 11 schematically illustrates that the eyes of a viewer focus on an object in long distance. (B) of FIG. 11 schematically illustrates that the eyes of a viewer focus on an object in short distance. As illustrated in (C) of FIG. 11, displaying parallax images corresponding to the angle of vergence on the image forming elements for the right eye 30R and the left eye 30L causes the viewer to feel depth in a case where the vergence distance varies. Each of the eyepiece optical systems, however, has constant virtual image distance for output. The accommodation distance of the eyes does not thus vary. Mismatch between the vergence distance and the accommodation distance causes the viewer to feel uncomfortable or sick in viewing, for example.

To solve the “mismatch problem with vergence distance and accommodation distance”, the head-mounted virtual image display apparatus according to the first embodiment includes a sliding mechanism 90 (see (B) of FIG. 12 described below) that slides the first image forming element 11 in the optical axis direction of the first eyepiece optical system 21 to allow the virtual image distance of an image to be controlled. The image is outputted to the front region of a viewer.

FIG. 12 illustrates an example of the movement amount of an image forming element necessary to control the virtual image distance in the head-mounted virtual image display apparatus according to the first embodiment along with a comparative example. (B) of FIG. 12 illustrates, as an example, the movement amount of the first image forming element 11 necessary to control the virtual image distance of the first eyepiece optical system 21 for output from 20 mm in front of a viewer to the infinity. In FIG. 12, (A) illustrates a conventional design example as a comparative example. In the conventional design example, an image forming element 111 of several inches is presupposed. An eyepiece optical system 121 has a long focal distance of about 40 mm. This causes the image forming element 111 to request a large movement amount of 5.5 mm. A relatively large actuator is necessary for a sliding mechanism. In FIG. 12, (B) illustrates a design example of the head-mounted virtual image display apparatus according to the first embodiment. The first eyepiece optical system 21 has a short focal distance of about 20 mm. This causes the first image forming element 11 to require a small movement amount of 1.5 mm. It is possible to adopt a relatively small and responsive actuator including a piezoelectric element and the like as the sliding mechanism 90. As a result, the head-mounted virtual image display apparatus according to the first embodiment is able to control virtual image distance in a relatively small and light-weighted configuration.

It is to be noted that only the first image forming element 11 is configured to slide in the design examples of FIG. 12, but a control mechanism for virtual image distance is not limited thereto. The first to fourth eyepiece optical systems 21 to 24 may be designed to slide the positions of lenses and lens groups included in the respective eyepiece optical systems or the positions of the image forming elements corresponding to the respective eyepiece optical systems, thereby making it possible to control the virtual image distance. In this way, a more flexible optical design makes it possible to control virtual image distance and satisfy the requirement of image quality and the requirement of housing size.

### (Virtual Image Display Method)

The optical designs of the head-mounted virtual image display apparatus according to the first embodiment have been described so far. To seamlessly join together images separately displayed by the first to fourth image forming elements 11 to 14, appropriate image processing is necessary. In the virtual image display method according to the first embodiment, a correction process is performed on images by taking into consideration the optical characteristics of the respective eyepiece optical systems such as aberration and peripheral darkening. The images are displayed on the respective image forming elements. In addition, a correction process is performed on images by taking into consideration the characteristics of a pencil of light rays such as darkening caused by the vignetting of the pencil of light rays, further the light emission characteristics of the first to fourth image forming elements 11 to 14 such as light distribution, chromaticity, and spectra, and the like. The images are displayed on the respective image forming elements. The characteristics of the pencil of light rays are geometrically determined from the pupil position and the pupil diameter of a viewer and the position and the inclination angle of the boundary surface in the eyepiece optical systems. The head-mounted virtual image display apparatus according to the first embodiment may include a display image correction section 45 that performs this correction process (see FIG. 13 described below).

Here, the correction process varies in accordance with the state of eyeball rotation. It is therefore desirable that the correction process be adjusted in real time by detecting the line-of-sight direction of a viewer. To detect the line-of-sight direction of a viewer, it is sufficient if an infrared light source is disposed in front of an eye and an imaging device including a lens barrel and an imaging element simultaneously shoots a corneal reflection image of the light source and an image of a pupil to identify the line-of-sight direction from the relative positional relationship (pupil center corneal reflection). The infrared light source does not affect viewing. It is then desirable to shoot images from the direction points to the right front of the eye as much as possible to increase the detection accuracy of the line-of-sight direction. In the present embodiment, the first image forming element 11 is, however, small. This increases the volume density of lenses in the first eyepiece optical system 21. It is possible to dispose the imaging device in limited space.

FIG. 13 schematically illustrates first to third disposition examples of an imaging device for detecting the line-of-sight direction in the head-mounted virtual image display apparatus according to the first embodiment. In FIG. 13, (A) and (B) illustrate design examples in each of which an imaging device is disposed outside the first to fourth eyepiece optical systems 21 to 24. In FIG. 13, (A) (first disposition example) illustrates that one imaging device 40 is configured to directly shoot an image of an eye of the viewer 31 from the nose side. In FIG. 13, (B) (second disposition example) illustrates that one imaging device 40 is configured to directly shoot an image of an eye of the viewer 31 from the lower side. An imaging result of the imaging device 40 is outputted to the display image correction section 45. The display image correction section 45 performs the correction process described above on the basis of the imaging result of the imaging device 40.

It is to be noted that (A) and (B) of FIG. 13 illustrate examples in which the one imaging device 40 is disposed, but two or more imaging devices may be configured to be disposed.

In contrast, in FIG. 13, in the design example of (C) (third disposition example), four imaging devices 41 to 44 are disposed around the first image forming element 11 between the first to fourth image forming elements 11 to 14 and the first to fourth eyepiece optical systems 21 to 24. This configures any of the first to fourth eyepiece optical systems 21 to 24 to shoot an image of an eye of the viewer 31. The three imaging devices 42 to 44 of the four imaging devices 41 to 44 are disposed between the first image forming element 11 and the second to fourth image forming elements 12 to 14. Such a method makes it possible to perform an appropriate correction process in accordance with the state of eyeball rotation. This makes it possible to seamlessly join a plurality of images even in the presence of the line-of-sight movement of the viewer 31. It is thus possible to alleviate the risk that the border between images is visually recognized. Imaging results of the imaging devices 41 to 44 are outputted to the display image correction section 45. The display image correction section 45 performs the correction process described above on the basis of the imaging results of the imaging devices 41 to 44.

It is to be noted that (C) of FIG. 13 illustrates an example in which the four imaging devices 41 to 44 are disposed, but three or less or five or more imaging devices may be configured to be disposed between the first to fourth image forming elements 11 to 14 and the first to fourth eyepiece optical systems 21 to 24.

In addition, an imaging device may also be included that shoots a landscape image of the outside. This may allow for a configuration in which it is possible, for example, to display the landscape image of the outside shot by the imaging device.

FIG. 14 schematically illustrates a virtual image display method of allowing the head-mounted virtual image display apparatus according to the first embodiment to offer a natural sense of depth to a viewer in conjunction with a control operation for virtual image distance described above. As described above, in a case where the line-of-sight direction of a viewer is detected, appropriate vergence distance is determined in accordance with the angle of vergence obtained from the line-of-sight direction. In FIG. 14, (A) illustrates a case where vergence distance Da of a viewer matches with a first object 51 in the foreground. The first object 51 is a sphere. A control mechanism (sliding mechanism 90) for the virtual image distance then moves the position of a virtual image surface that is outputted. This causes the accommodation distance of an eye to match with the vergence distance Da corresponding to an angle θa of vergence. Further, the display image correction section 45 described above performs parallax image processing accompanying a vergence angle shift or a blur process on a display object that is out of the vergence distance Da and the viewer is not gazing at. In FIG. 14, (B) illustrates a case where vergence distance Db of a viewer matches with a second object 52 in the background. The second object 52 is a cube. Here, similarly, the sliding mechanism 90 moves the position of a virtual image surface to cause the accommodation distance of an eye to match with the vergence distance Db corresponding to an angle θb of vergence. In addition, the display image correction section 45 performs parallax image processing or a blur process on a display object at which a viewer is not gazing.

Such a method solves the “mismatch problem with vergence distance and accommodation distance” and makes a viewer feel less uncomfortable or less sick in viewing, for example. It is to be noted that a control mechanism for virtual image distance shifts a single virtual image surface back and forth and it is not possible to output a three-dimensional surface in real space. However, human eyes originally have accommodation distance for a gazing point. Even the virtual image display method described above causes no problem.

### 1.2 Effects

As described above, the head-mounted virtual image display apparatus and the virtual image display method according to the first embodiment make it possible to achieve relative smallness and light weight and achieve both high resolution and a wide viewing angle while suppressing manufacturing cost. This makes it possible to provide a viewer with comfortable wearability and a sense of immersion.

It is to be noted that the effects described in this specification are merely illustrative and non-limiting. In addition, there may be any other effect. This also holds true for the effects of the following other embodiments.

### 2. Second Embodiment

Next, a head-mounted virtual image display apparatus and a virtual image display method according to a second embodiment of the present disclosure are described. It is to be noted that the following denotes components which are substantially the same as those of the head-mounted virtual image display apparatus and the virtual image display method according to the first embodiment described above with the same signs and omits the description thereof where appropriate.

FIG. 15 illustrates a configuration example of the first and second eyepiece optical systems 21 and 22 included in the optical unit for the right eye 30R in the head-mounted virtual image display apparatus according to the second embodiment of the present disclosure along with optical paths. In the head-mounted virtual image display apparatus according to the second embodiment, the optical unit for the right eye 30R includes the first and second image forming elements 11 and 12 and the first and second eyepiece optical systems 21 and 22 for joining together respective images displayed on the first and second image forming elements 11 and 12 into one virtual image and viewing the virtual image.

The first image forming element 11 is a high-definition and small image forming element. The first image forming element 11 displays an image that is outputted to the front region in the visual field of a viewer. In a case of the second embodiment, the first image forming element 11 has a pixel pitch of 10.6 μm, a horizontal pixel count of 2260 pixels, and a vertical pixel count of 2560 pixels. The first image forming element 11 is, for example, M-OLED.

The second image forming element 12 is disposed on the right side of the first image forming element 11. The second image forming element 12 displays an image that is outputted to the right peripheral region in the visual field of a viewer. The second image forming element 12 has a greater pixel pitch than that of the first image forming element 11. The second image forming element 12 has a pixel pitch of 65.25 μm, a horizontal pixel count of 400 pixels, and a vertical pixel count of 750 pixels. The second image forming element 12 is, for example, LTPS-OLED.

The first and second eyepiece optical systems 21 and 22 are designed to be able to output field angle regions separately displayed by the first and second image forming elements 11 and 12. The optical unit for the right eye 30R outputs, as a whole, a virtual image having a horizontal field angle within a range of −55° or more and 75° or less.

The first eyepiece optical system 21 includes the first L1 lens L11, the first L2 lens L12, and the first L3 lens L12. In addition, the opposed surfaces of the first L1 lens L11 and the first L2 lens L12 are both optically designed as Fresnel lenses. This makes it possible to achieve a reduction in optical unit height and weight and further achieve a reduction in apparatus height and weight as a whole as compared with an optical design in which only a standard spherical lens and a standard aspherical lens are adopted.

In the optical unit for the right eye 30R, the second eyepiece optical system 22 that outputs a virtual image to a peripheral region in the visual field of a viewer includes a second L1 lens L21 and a second L2 lens L22. In addition, the second L2 lens L22 is optically designed as one-surface reflection type free-form surface prism.

Such a configuration assumes that a viewer wears a virtual image display apparatus with glasses on. Such a configuration prevents the apparatus from increasing in size as a whole and facilitates a design in which sufficient space is secured in front of the eyes (space from the face of a viewer to the lens surface that is the closest to the eyes).

The other configurations, operations, and effects may be substantially similar to those of the head-mounted virtual image display apparatus and the virtual image display method according to the first embodiment described above.

### 3. Third Embodiment

Next, a head-mounted virtual image display apparatus and a virtual image display method according to a third embodiment of the present disclosure are described. It is to be noted that the following denotes components which are substantially the same as those of the head-mounted virtual image display apparatus and the virtual image display method according to the first or second embodiment described above with the same signs and omits the description thereof where appropriate.

FIG. 16 illustrates a configuration example of the first and second eyepiece optical systems 21 and 22 included in the optical unit for the right eye 30R in the head-mounted virtual image display apparatus according to the third embodiment of the present disclosure along with optical paths. The optical unit for the right eye 30R includes the first and second image forming elements 11 and 12 and the first and second eyepiece optical systems 21 and 22 for joining together respective images displayed on the first and second image forming elements 11 and 12 into one virtual image and viewing the virtual image.

The first and second eyepiece optical systems 21 and 22 are designed to be able to output field angle regions separately displayed by the first and second image forming elements 11 and 12. The optical unit for the right eye 30R outputs, as a whole, a virtual image having a horizontal field angle within a range of −45° or more and 70° or less.

The first eyepiece optical system 21 includes the first L1 lens L11, the first L2 lens L12, and a first L3 lens L13. In addition, the opposed surfaces of the first L1 lens L11 and the first L2 lens L12 are both optically designed as Fresnel lenses. This makes it possible to achieve a reduction in optical unit height and weight and further achieve a reduction in apparatus height and weight as a whole as compared with an optical design in which only a standard spherical lens and a standard aspherical lens are adopted.

In the optical unit for the right eye 30R, the second eyepiece optical system 22 that outputs a virtual image to a peripheral region in the visual field of a viewer includes the second L1 lens L21 that is optically designed as a two-surface reflection type free-form surface prism.

Such a configuration also allows for a design in which a heated portion is put away from the face of a viewer in a case where there is a concern that heat is generated from the second image forming element 12, a control circuit (not illustrated) for the second image forming element 12, and the like.

The head-mounted virtual image display apparatus according to the third embodiment does not have the boundary surface 72 between the first eyepiece optical system 21 and the second eyepiece optical system 22. It is a lens cut surface 161 that is at the position corresponding to the boundary surface 72 in the first eyepiece optical system 21. It is preferable that the position and the inclination angle of the lens cut surface 161 in the first eyepiece optical system 21 be designed as with the position and the inclination angle of the boundary surface 72 between the first and second eyepiece optical systems 21 and 22 according to the first embodiment.

The other configurations, operations, and effects may be substantially similar to those of the head-mounted virtual image display apparatus and the virtual image display method according to the first embodiment described above.

### 4. Fourth Embodiment

Next, a head-mounted virtual image display apparatus and a virtual image display method according to a fourth embodiment of the present disclosure are described. It is to be noted that the following denotes components which are substantially the same as those of the head-mounted virtual image display apparatus and the virtual image display method according to any of the first to third embodiments described above with the same signs and omits the description thereof where appropriate.

FIG. 17 illustrates a configuration example of the first and second eyepiece optical systems 21 and 22 included in the optical unit for the right eye 30R in the head-mounted virtual image display apparatus according to the fourth embodiment of the present disclosure along with optical paths. The optical unit for the right eye 30R includes the first and second image forming elements 11 and 12 and the first and second eyepiece optical systems 21 and 22 for joining together respective images displayed on the first and second image forming elements 11 and 12 into one virtual image and viewing the virtual image.

The first and second eyepiece optical systems 21 and 22 are designed to be able to output field angle regions separately displayed by the first and second image forming elements 11 and 12. The optical unit for the right eye 30R outputs, as a whole, a virtual image having a horizontal field angle within a range of −45° or more and 70° or less.

The first eyepiece optical system 21 includes the first L1 lens L11, the first L2 lens L12, and the first L3 lens L13. In addition, the opposed surfaces of the first L1 lens L11 and the first L2 lens L12 are both optically designed as Fresnel lenses. This makes it possible to achieve a reduction in optical unit height and weight and further achieve a reduction in apparatus height and weight as a whole as compared with an optical design in which only a standard spherical lens and a standard aspherical lens are adopted.

In the optical unit for the right eye 30R, the second eyepiece optical system 22 that outputs a virtual image to a peripheral region in the visual field of a viewer includes a second M1 mirror M21 that is optically designed as a relatively simple free-form surface mirror.

Such a configuration allows for a design in which a heated portion is put away from the face of a viewer in a case where there is a concern that heat is generated from the second image forming element 12, a control circuit (not illustrated) for the second image forming element 12, and the like.

The head-mounted virtual image display apparatus according to the fourth embodiment does not have the boundary surface 72 between the first eyepiece optical system 21 and the second eyepiece optical system 22. It is the lens cut surface 161 that is at the position corresponding to the boundary surface 72 in the first eyepiece optical system 21. It is preferable that the position and the inclination angle of the lens cut surface 161 in the first eyepiece optical system 21 be designed as with the position and the inclination angle of the boundary surface 72 between the first and second eyepiece optical systems 21 and 22 according to the first embodiment.

The other configurations, operations, and effects may be substantially similar to those of the head-mounted virtual image display apparatus and the virtual image display method according to the first embodiment described above.

### 5. Fifth Embodiment

Next, a head-mounted virtual image display apparatus and a virtual image display method according to a fifth embodiment of the present disclosure are described. It is to be noted that the following denotes components which are substantially the same as those of the head-mounted virtual image display apparatus and the virtual image display method according to any of the first to fourth embodiments described above with the same signs and omits the description thereof where appropriate.

FIG. 18 illustrates a configuration example of the first and second eyepiece optical systems 21 and 22 included in the optical unit for the right eye 30R in the head-mounted virtual image display apparatus according to the fifth embodiment of the present disclosure along with optical paths. The optical unit for the right eye 30R includes the first and second image forming elements 11 and 12 and the first and second eyepiece optical systems 21 and 22 for joining together respective images displayed on the first and second image forming elements 11 and 12 into one virtual image and viewing the virtual image.

The first and second eyepiece optical systems 21 and 22 are designed to be able to output field angle regions separately displayed by the first and second image forming elements 11 and 12. The optical unit for the right eye 30R outputs, as a whole, a virtual image having a horizontal field angle within a range of −50° or more and 75° or less.

The first eyepiece optical system 21 includes the first L1 lens L11, the first L2 lens L12, the first L3 lens L13, and a first L4 lens L14.

The second eyepiece optical system 22 includes the second L1 lens L21, the second L2 lens L22, and a second L3 lens L23. Further, in the first and second eyepiece optical systems 21 and 22, the respective L1 lenses (first L1 lens L11 and second L1 lens L21) are optically designed to be shared as the same lens.

In general, a lens surface farther from an eye varies less in light ray height along with eyeball rotation. Thus, dividing the second or subsequent lens group from the eye side causes a pencil of light rays to have less vignetting than vignetting caused by dividing the first and subsequent lenses from the eye side. This makes it possible to reduce superimposed regions that are set for two adjacent images. It is thus possible to increase the use efficiency of the pixels included in the first and second image forming elements 11 and 12.

Further, in the configuration of the eyepiece optical systems according to the fifth embodiment, the L1 lens is common to the first and second eyepiece optical systems 21 and 22. No ridge line is thus formed on the lens surface. This also alleviates the risk that a ridge line is visually recognized on the L1 lens.

The head-mounted virtual image display apparatus according to the fifth embodiment does not have the boundary surface 72 between the first eyepiece optical system 21 and the second eyepiece optical system 22. It is the lens cut surface 161 that is at the position corresponding to the boundary surface 72 in the first eyepiece optical system 21. It is preferable that the position and the inclination angle of the lens cut surface 161 in the first eyepiece optical system 21 be designed as with the position and the inclination angle of the boundary surface 72 between the first and second eyepiece optical systems 21 and 22 according to the first embodiment.

The other configurations, operations, and effects may be substantially similar to those of the head-mounted virtual image display apparatus and the virtual image display method according to the first embodiment described above.

### 6. Another Embodiment

The technology according to the present disclosure is not limited to the descriptions of the respective embodiments described above, but may be modified in a variety of ways.

For example, the present technology may also have configurations as follows.

The present technology having the following configurations makes it possible to provide a viewer with comfortable wearability and a sense of immersion.

(1)

A virtual image display apparatus including:

a plurality of image forming elements including a first image forming element and a second image forming element, the first image forming element outputting a first image to a front region in a visual field of a viewer, the second image forming element outputting a second image to a peripheral region in the visual field of the viewer, the second image being different from the first image, the plurality of image forming elements outputting a plurality of images to cause an image region of at least a portion of each of the plurality of images to overlap with the first image, the plurality of images including the first and second images; and

a plurality of eyepiece optical systems that is provided in association with the plurality of respective image forming elements, the plurality of eyepiece optical systems forming one virtual image as a whole from the plurality of images.

(2)

The virtual image display apparatus according to (1), in which the first image is higher than the second image in resolution.

(3)

The virtual image display apparatus according to (1) or (2), in which

the plurality of eyepiece optical systems includes a first eyepiece optical system that is provided in association with the first image forming element, and

the first eyepiece optical system is configured to output a virtual image having 60° or more and 120° or less as a horizontal field angle and 45° or more and 100° or less as a vertical field angle.

(4)

The virtual image display apparatus according to any one of (1) to (3), in which the first image forming element has a resolution of 2000 ppi or more and the second image forming element has a resolution of less than 2000 ppi.

(5)

The virtual image display apparatus according to any one of (1) to (4), in which a position of a boundary surface between two given adjacent eyepiece optical systems is designed in the plurality of eyepiece optical systems to join two given adjacent virtual images with no gap while causing the two given adjacent virtual images to constantly have partially overlapping regions in spite of a line-of-sight movement of the viewer, the two given adjacent virtual images being outputted from the two respective given adjacent eyepiece optical systems.

(6)

The virtual image display apparatus according to any one of (1) to (5), in which an inclination angle of a boundary surface between two given adjacent eyepiece optical systems is designed in the plurality of eyepiece optical systems to suppress vignetting of a pencil of light rays for a line-of-sight movement of the viewer, the pencil of light rays passing by near the boundary surface.

(7)

The virtual image display apparatus according to any one of (1) to (6), in which the plurality of eyepiece optical systems is configured to form a smoothly curved virtual image surface as a whole to cover the viewer's field of vision or form a discretely curved virtual image surface as a whole to cover the viewer's field of vision by causing an eyepiece optical system disposed closer to a periphery to form a more inclined virtual image surface while each of the eyepiece optical systems forms a flat virtual image surface.

(8)

The virtual image display apparatus according to any one of (1) to (7), in which at least one eyepiece optical system of the plurality of eyepiece optical systems includes a Fresnel lens.

(9)

The virtual image display apparatus according to any one of (1) to (8), in which one eyepiece optical system of the plurality of eyepiece optical systems is configured by using an optical scheme that is different from an optical scheme of another eyepiece optical system.

(10)

The virtual image display apparatus according to (9), in which the other eyepiece optical system is configured by using an optical scheme in which a free-form surface prism or a free-form surface mirror is included.

(11)

The virtual image display apparatus according to any one of (1) to (7), in which at least a surface positioned closest to an eye side of the viewer in the plurality of eyepiece optical systems serves as a lens surface shared between the respective eyepiece optical systems.

(12)

The virtual image display apparatus according to any one of (1) to (11), further including a sliding mechanism configured to control virtual image distance from the observer to a virtual image surface by each of the plurality of eyepiece optical systems by sliding a position of a component in each of the plurality of eyepiece optical systems or a position of each of the plurality of image forming elements.

(13)

The virtual image display apparatus according to (12), in which the sliding mechanism is configured to control the virtual image distance from 20 mm in front of the viewer to infinity.

(14)

A virtual image display method including:

a step of displaying a plurality of images by a plurality of respective image forming elements;

a step of outputting the plurality of images via a plurality of eyepiece optical systems corresponding to the plurality of respective image forming elements; and

a step of correcting images that are displayed on the plurality of image forming elements on the basis of at least one of optical characteristics of the plurality of eyepiece optical systems, characteristics of a pencil of light rays, or light emission characteristics of the plurality of image forming elements to cause images outputted via the plurality of eyepiece optical systems to form the one virtual image, the characteristics of the pencil of light rays being geometrically determined from a pupil position and a pupil diameter of the viewer and a position and an inclination angle of a boundary surface in the eyepiece optical systems.

(15)

The virtual image display method according to (14), in which

the optical characteristics include characteristics of the plurality of eyepiece optical systems regarding aberration and peripheral darkening, and

the light emission characteristics include characteristics of the plurality of image forming elements regarding light distribution, chromaticity, and spectra.

(16)

The virtual image display method according to (14) or (15), further including a step of adjusting the correction on the images in accordance with a line-of-sight direction of the viewer, the images being displayed on the plurality of image forming elements.

(17)

The virtual image display method according to any one of (14) to (16), further including:

a step of controlling virtual image distance from the observer to a virtual image surface by each of the plurality of eyepiece optical systems in accordance with the viewer's angle of vergence while detecting a line-of-sight direction of the viewer by sliding a position of a component in each of the plurality of eyepiece optical systems or a position of each of the plurality of image forming elements with a sliding mechanism; and

a step of, in conjunction with an operation of the sliding mechanism, adjusting the images that are displayed on the plurality of image forming elements at display positions corresponding to magnification of the plurality of eyepiece optical systems and the observer's angle of vergence and performing correction to subject a display object at which the viewer is not gazing to a blur process, the display object being out of vergence distance.

The present application claims priority based on Japanese Patent Application No. 2018-211365 filed with Japan Patent Office on Nov. 9, 2018 and Japanese Patent Application No. 2019-040813 filed with Japan Patent Office on Mar. 6, 2019, the entire contents of each which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A virtual image display apparatus comprising:
a plurality of image forming elements including a first image forming element and a second image forming element, the first image forming element outputting a first image to a front region in a visual field of a viewer, the second image forming element outputting a second image to a peripheral region in the visual field of the viewer, the second image being different from the first image, the plurality of image forming elements outputting a plurality of images to cause an image region of at least a portion of each of the plurality of images to overlap with the first image, the plurality of images including the first and second images; and
a plurality of eyepiece optical systems that is provided in association with the plurality of respective image forming elements, the plurality of eyepiece optical systems forming one virtual image as a whole from the plurality of images.

2. The virtual image display apparatus according to claim 1, wherein the first image is higher than the second image in resolution.

3. The virtual image display apparatus according to claim 1, wherein
the plurality of eyepiece optical systems includes a first eyepiece optical system that is provided in association with the first image forming element, and
the first eyepiece optical system is configured to output a virtual image having 60° or more and 120° or less as a horizontal field angle and 45° or more and 100° or less as a vertical field angle.

4. The virtual image display apparatus according to claim 1, wherein the first image forming element has a resolution of 2000 ppi or more and the second image forming element has a resolution of less than 2000 ppi.

5. The virtual image display apparatus according to claim 1, wherein a position of a boundary surface between two given adjacent eyepiece optical systems is designed in the plurality of eyepiece optical systems to join two given adjacent virtual images with no gap while causing the two given adjacent virtual images to constantly have partially overlapping regions in spite of a line-of-sight movement of the viewer, the two given adjacent virtual images being outputted from the two respective given adjacent eyepiece optical systems.

6. The virtual image display apparatus according to claim 1, wherein an inclination angle of a boundary surface between two given adjacent eyepiece optical systems is designed in the plurality of eyepiece optical systems to suppress vignetting of a pencil of light rays for a line-of-sight movement of the viewer, the pencil of light rays passing by near the boundary surface.

7. The virtual image display apparatus according to claim 1, wherein the plurality of eyepiece optical systems is configured to form a smoothly curved virtual image surface as a whole to cover the viewer's field of vision or form a discretely curved virtual image surface as a whole to cover the viewer's field of vision by causing an eyepiece optical system disposed closer to a periphery to form a more inclined virtual image surface while each of the eyepiece optical systems forms a flat virtual image surface.

8. The virtual image display apparatus according to claim 1, wherein at least one eyepiece optical system of the plurality of eyepiece optical systems includes a Fresnel lens.

9. The virtual image display apparatus according to claim 1, wherein one eyepiece optical system of the plurality of eyepiece optical systems is configured by using an optical scheme that is different from an optical scheme of another eyepiece optical system.

10. The virtual image display apparatus according to claim 9, wherein the other eyepiece optical system is configured by using an optical scheme in which a free-form surface prism or a free-form surface mirror is included.

11. The virtual image display apparatus according to claim 1, wherein at least a surface positioned closest to an eye side of the viewer in the plurality of eyepiece optical systems serves as a lens surface shared between the respective eyepiece optical systems.

12. The virtual image display apparatus according to claim 1, further comprising a sliding mechanism configured to control virtual image distance from the observer to a virtual image surface by each of the plurality of eyepiece optical systems by sliding a position of a component in each of the plurality of eyepiece optical systems or a position of each of the plurality of image forming elements.

13. The virtual image display apparatus according to claim 12, wherein the sliding mechanism is configured to control the virtual image distance from 20 mm in front of the viewer to infinity.

14. A virtual image display method comprising:
a step of displaying a plurality of images by a plurality of respective image forming elements;
a step of outputting the plurality of images via a plurality of eyepiece optical systems corresponding to the plurality of respective image forming elements; and
a step of correcting images that are displayed on the plurality of image forming elements on a basis of at least one of optical characteristics of the plurality of eyepiece optical systems, characteristics of a pencil of light rays, or light emission characteristics of the plurality of image forming elements to cause images outputted via the plurality of eyepiece optical systems to form the one virtual image, the characteristics of the pencil of light rays being geometrically determined from a pupil position and a pupil diameter of the viewer and a position and an inclination angle of a boundary surface in the eyepiece optical systems.

15. The virtual image display method according to claim 14, wherein
the optical characteristics include characteristics of the plurality of eyepiece optical systems regarding aberration and peripheral darkening, and
the light emission characteristics include characteristics of the plurality of image forming elements regarding light distribution, chromaticity, and spectra.

16. The virtual image display method according to claim 14, further comprising a step of adjusting the correction on the images in accordance with a line-of-sight direction of the viewer, the images being displayed on the plurality of image forming elements.

17. The virtual image display method according to claim 14, further comprising:
a step of controlling virtual image distance from the observer to a virtual image surface by each of the plurality of eyepiece optical systems in accordance with the viewer's angle of vergence while detecting a line-of-sight direction of the viewer by sliding a position of a component in each of the plurality of eyepiece optical systems or a position of each of the plurality of image forming elements with a sliding mechanism; and
a step of, in conjunction with an operation of the sliding mechanism, adjusting the images that are displayed on the plurality of image forming elements at display positions corresponding to magnification of the plurality of eyepiece optical systems and the observer's angle of vergence and performing correction to subject a display object at which the viewer is not gazing to a blur process, the display object being out of vergence distance.
